(19) United States
(12) Patent Application Publication
(10) Pub. No.: US 2017/0070343 A1
(43) Pub. Date: Mar. 9, 2017

(54) UNICAST KEY MANAGEMENT ACROSS MULTIPLE NEIGHBORHOOD AWARE NETWORK DATA LINK GROUPS

(71) Applicant: QUALCOMM Incorporated, San Diego, CA (US)

(72) Inventors: Abhishek Pramod Patil, San Diego, CA (US); Santosh Paul Abraham, San Diego, CA (US); George Cherian, San Diego, CA (US); Alireza Raissinia, Monte Sereno, CA (US)

(21) Appl. No.: 14/845,712

(22) Filed: Sep. 4, 2015

(51) Int. Cl. H04L 9/08; H04W 12/04; H04W 76/02

(52) U.S. Cl. CPC H04L 9/0816; H04W 76/025; H04W 76/023; H04W 12/04

(57) ABSTRACT

Methods, systems, and devices are described for unicast key management across multiple neighborhood aware network (NAN) data link networks (NDL) comprising: establishing, by a first device, a first association with a second device via a first data link; establishing, by the first device, a second association with the second device via a second data link; and using a single unicast key to encrypt unicast traffic transmitted via the first data link and the second data link between the first device and the second device.

### BACKGROUND

Field of the Disclosure

The following relates generally to wireless communication, and more particularly to unicast key management across multiple neighborhood aware network (NAN) data links (NDL) groups.

Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (Institute of Electrical and Electronic Engineers (IEEE) 802.11) may include an access point (AP) that may communicate with wireless devices. The AP may be coupled to a network, such as the Internet, and enable a wireless device to communicate via the network (and/or communicate with other devices coupled to the access point). Wireless devices may communicate directly via a wireless mesh or peer-to-peer (P2P) network where wireless devices may form a network without base station, APs, or other equipment. One example of a P2P network includes a synchronized cluster of wireless devices, also referred to as a neighbor aware network (NAN).

A subset of wireless devices of the NAN may form a direct wireless data link to support communications for the NAN, also referred to as a NAN direct link or NDL. NDL networks are dynamically self-organized and self-configured with wireless devices in the network automatically establishing an ad-hoc network with other wireless devices such that the network connectivity can be maintained. In an NDL, each device or node relays data for the network and all stations cooperate in the distribution of data within the network. Current systems, however, do not fully take into account the network connectivity issues that arise for new wireless devices that wish to join more than one NDL network group.

### SUMMARY

The described features generally relates to one or more improved systems, methods and/or apparatuses for unicast key management across multiple neighborhood aware network (NAN) data links (NDL) groups. In general, the approach is directed to methods and systems in which a single wireless device joins multiple NDL groups by way of associating with a NDL group member device.

A method for wireless communications is described. The method may include establishing a first association between a first device seeking to join a first NDL group (“joining device”) and a second device which is already a member of the first NDL group (“member device”). The first association may be established via a first data link. The first device establishes a second association related to a second NDL group with the second device. The second association is established via a second data link. A single unicast key is used to encrypt traffic transmitted via the first data link and the second data link between the first device and the second device.

The method may be performed wherein the first data link is a first NDL and the second data link is a second NDL, where the second NDL is different from the first NDL.

The method may involve generating a first unicast key to encrypt traffic transmitted via the first data link and generating a second unicast key to encrypt unicast traffic transmitted via the second data link.

The method may involve identifying a first pairwise transient key (PTK) used to encrypt unicast traffic between the first device and the second device, where the first PTK is used as a first unicast key; identifying a second PTK used to encrypt unicast traffic between the first device and the second device, where the second PTK is used as a second unicast key; receiving a data frame from the second device, where the data frame contains header information; selecting one of the first PTK or the second PTK based on the header information; and decrypting the data frame based on the selected PTK.

The method may involve identifying the first unicast key as being generated prior to the generation of the second unicast key; discarding the first unicast key based at least in part on the identifying; and using the second unicast key as the single unicast key to encrypt unicast traffic transmitted via the first data link and the second data link.

The method may involve identifying the second association with the second device via the second data link as being an unsecure connection; using the first unicast key as the single unicast key to encrypt unicast traffic transmitted via the first data link; and transmitting unencrypted unicast traffic via the second data link.

The method may involve maintaining a map that identifies previously established associations between the first device and other devices.

The method may involve determining an association with the second device was previously established based at least in part on the map which identifying previously established associations between the first device and other devices; identifying a previously generated PTK used to encrypt traffic between the first device and the second device; and mapping the second association to the previously generated PTK, where the previously generated PTK is used as unicast key to encrypt unicast traffic transmitted via the first data link and the second data link.

The method may involve determining the first association with the second device was not previously established based at least in part on the previously described map; and generating a PTK used to encrypt traffic between the first device and the second device, the generated PTK used as the single unicast key to encrypt unicast traffic transmitted via the first data link and the second data link.

The method may involve establishing a first association further involves generating a pairwise master key (PMK) with the second device.

The method may involve establishing the first association prior in time to the establishment of the second association.

An apparatus for wireless communications is disclosed. The apparatus may include a key manager to establish a first association between a first device and a second device by way of a first data link. The key manager may further establish a second association between the first device and the second device by way of a second data link. The apparatus may use a single unicast key to encrypt unicast traffic between the first device and the second device transmitted by way of the first data link and the second data link.

Another apparatus for wireless communication is disclosed. The apparatus may include a means for establishing, by a first device, a first association with a second device via a first data link; a means for establishing, by the first device, a second association with the second device via a second data link; and a means for using a single unicast key to encrypt unicast traffic transmitted via the first data link and the second data link between the first device and the second device.

A non-transitory computer-readable medium storing code for wireless communication is described. The code may be executable by way of a processor to: establish a first association between a first device and a second device by way of a first data link; establish a second association between the first device and the second device by way of a second data link; and use a single unicast key to encrypt unicast traffic between the first device and the second device transmitted by way of the first data link and the second data link.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a wireless communication system, in accordance with various aspects of the present disclosure;

FIG. 2 is a message flow diagram illustrating a flow of communications between various devices, in accordance with various aspects of the present disclosure;

FIG. 3 is another message flow diagram illustrating a flow of communications between various devices, in accordance with various aspects of the present disclosure;

FIG. 4 is another message flow diagram illustrating a flow of communications between various devices, in accordance with various aspects of the present disclosure;

FIG. 5 is a block diagram illustrating an example of a wireless communication device, in accordance with various aspects of the present disclosure;

FIG. 6A is a block diagram illustrating another example of a wireless communication device, in accordance with various aspects of the present disclosure;

FIG. 6B is a block diagram illustrating yet another example of a wireless communication device, in accordance with various aspects of the present disclosure;

FIG. 7 is a block diagram of a device configured for use in wireless communication, in accordance with various aspects of the present disclosure;

FIG. 8 is a flow chart illustrating an example of a method for wireless communication, in accordance with various aspects of the present disclosure;

FIG. 9 is a flow chart illustrating another example of a method for wireless communication, in accordance with various aspects of the present disclosure; and

FIG. 10 is a flow chart illustrating yet another example of a method for wireless communication, in accordance with various aspects of the present disclosure.

### DETAILED DESCRIPTION

The present disclosure relates to improved systems, methods, and/or apparatuses for unicast key management across multiple neighbor aware network (NAN) data link (NDL) groups. In particular, the present disclosure is directed to a device joining multiple NDL groups. The device may associate with another device which is already a member of multiple NDL groups. The encryption of data between these devices may be enabled by way of a single unicast key sent between them.

In some examples, a direct wireless data link may be a fully connected network in which each member wireless device has a connection with every other wireless device in the network. Also, a direct wireless data link may be a partially connected network in which some member devices may be connected in a full connectivity scheme, but other member devices are only connected to some of the devices, but not all devices which comprise each NDL group.

Direct wireless data link networks may be used for static topologies and ad-hoc or NAN. The described techniques may be applied to various mesh network topologies and/or other peer-to-peer (P2P) networks. A network may include a plurality of devices or nodes, each of which can be capable of relaying data within the network on behalf of other devices in an NDL environment. The data transmitted or relayed between the devices may similarly create a data path (“DP”) wherein the “path” describes the data flow from one wireless device to another. Accordingly, an NDL may include data transferred from a service provider to a service consumer.

A direct wireless data link may include more than one “hop.” A “hop” as used herein depends on the number of devices between the device providing the service (member device) and the device consuming the service or “subscribing” (joining device) to the service. For example, a service that is relayed by one wireless device may be referred to as two hops: member device (hop one) to proxy device, (hop two) to joining device. While a direct wireless data link may refer to a subset or network of devices capable of one-hop service discovery, a direct wireless data link may be capable of service discovery and subscription over multiple hops (multi-hop).

In certain embodiments, a group of devices may connect to form an NDL. An NDL set may generally refer to a subset of a NAN cluster that shares a common timing parameter, e.g., a common paging window (PW) that precedes a common data transmission window (T×W). The T×W for the NDL group may have common security credentials for each of the devices, which may serve to restrict membership within the NDL. Accordingly, a restricted NDL may require out-of-band credentialing. Each NDL may also be associated with a unique identifier (ID), such as an NDL ID, that distinguishes NDL groups from each other. In some instances, the T×W for a first NDL may be the same or different from a T×W for a second NDL.

In an NDL, the group of devices generally share a common timing synchronization. For example, the group of devices of the NDL may be a subset of devices belonging to a NAN. The NAN typically uses a beaconing operation to time align the NAN member devices. As a result, the subset of devices of the NDL are synchronized. Therefore, the NDL typically does not include a beaconing operation. When a joining device is interested in joining an existing NDL, the joining device will authenticate and associate with a member device which is already a member of the NDL. Association between the two devices occurs if one or both of the devices has incoming or outgoing data transmissions to share. The association between the joining device and the member device thus occurs on a need-based schedule. In some embodiments, however, the joining device may join multiple NDLs.

In accordance with the present disclosure, unicast key management across multiple NDL groups is described. Specifically, a device wishing to join multiple NDL groups may do so by associating with one member device, where the member device is a member of multiple NDL networks.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

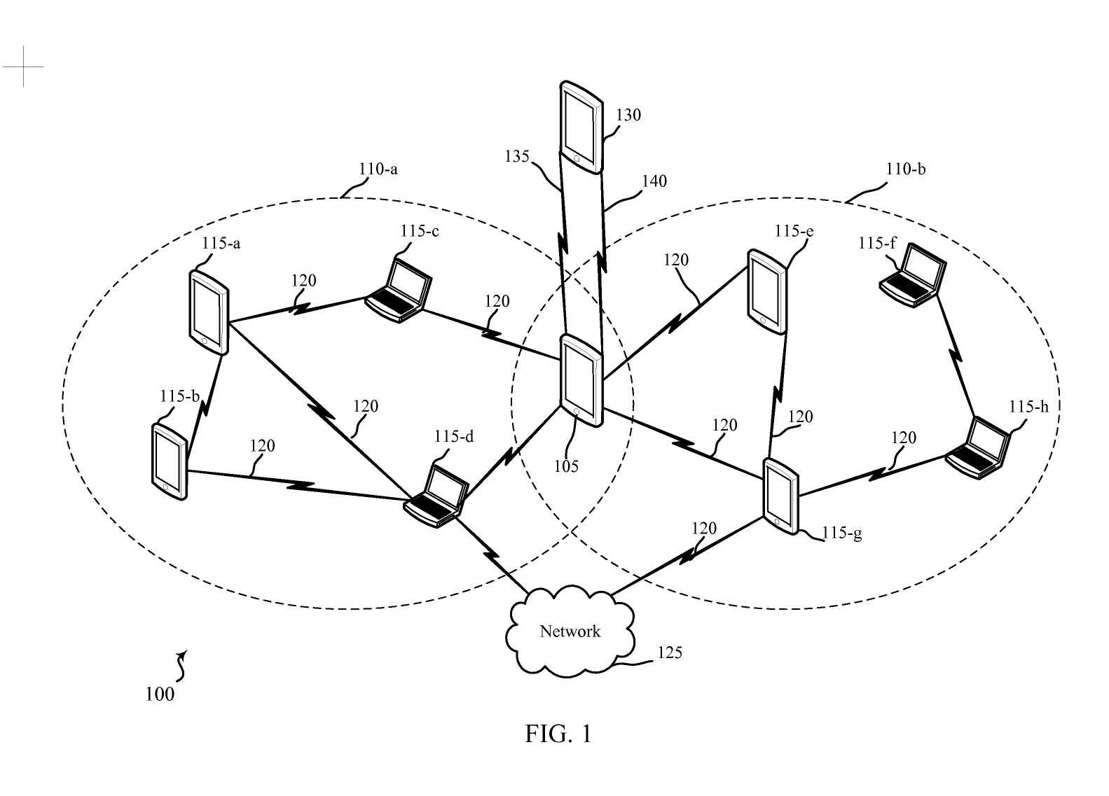

Referring first to FIG. 1, a block diagram illustrates an example of a WLAN network 100, which may be an example direct wireless data link, a data link network, or an NDL, configured in accordance with various aspects of the present disclosure. In one embodiment, the WLAN network includes two example NDL groups 110-a and 110-b. Each of the NDL groups 110-a and 110-b may be implemented as a wired or wireless communication network of various fixed and/or mobile devices that may be referred to as “nodes” or “devices”, such as mobile stations, personal digital assistants (PDAs), other handheld devices, netbooks, notebook computers, tablet computers, laptops, display devices (e.g., TVs, computer monitors, etc.), printers, etc. Each of the devices 105 and 115-a, 115-b, 115-c, and 115-d may receive and communicate data throughout the NDL group 110-a. Each of the devices 105 and 115-d, 115-e, 115-f, 115-g, and 115-h may receive and communicate data throughout the NDL group 110-b. In addition, any of the devices 105 and 115-a, 115-b, 115-c, 115-d, 115-e, 115-f, 115-g, and 115-h may route data from one device to another within the NDL group of which each device is part (i.e., 105 and 115-a, 115-b, 115-c, and 115-d within NDL group 110-a and 105, 115-e, 115-f, 115-g, and 115-h within NDL group 110-b). In addition, each of the devices may have more than one communication link 120 to and/or from other devices within each device's respective NDL group, which provides for redundant communication links and a reliable communication system. For instance, device 115-a may establish communication with device 115-d via either intermediate device 115-b or with 115-d directly.

As shown in FIG. 1, the NDL groups 110-a and 110-b can be a partially connected network, with connections or communication links 120 established between the devices 115, such that each of the devices may communicate with all of the other devices of the respective NDL group 110. The NDL groups 110-a and 110-b may be connected to an external network 125, such as the Internet, by at least one member device (e.g., devices 115-d and 115-g in this example) establishing a connection or communication link 120 with the external network 125. In one example, the device 115-g may establish its connection with a base station or access point that has access to the external network 125.

The NDL groups 110-a and 110-b may include devices 105 and 115 implemented for wireless communication utilizing a data packet routing protocol, such as Hybrid Wireless Mesh Protocol (HWMP) for path selection. In some examples, the NDL groups 110-a and 110-b may also be implemented for data communication with other networks that are communicatively linked to the network, such as with another wireless network, wired network, wide-area-network (WAN), and the like.

In one embodiment, wireless communication device 130 (joining device) may be in proximity of both NDL groups 110-a and 110-b. The joining device 130 may join the NDL group 110-a by associating with only one of the devices 115 of the NDL group 110-a. More specifically, the joining device 130 may associate with member device 105, where member device 105 is a member of NDL group 110-a. Communications between the joining device 130 and the member device 105 may be by way of a first data link 135. Upon successfully completing an association procedure, the joining device 130 may receive a unicast key common to the devices of the NDL group 110-a from member device 105 over the first data link 135. Data transferred between the joining device 130 and the member device over the first data link 135 (e.g., within NDL group 110-a) may be encrypted and/or decrypted using the unicast key received by the joining device 130.

Because member device 105 is a member of both NDL groups 110-a and 110-b, joining device 130 may also join the NDL group 110-b by way of the previously established association with member device 105. Communications between the joining device 130 and member device 105 with regard to the second association, and with regard to joining the second NDL, are via a second data link 140. In one embodiment, upon successfully completing an association between joining device 130 and member device 105, the joining device 130 may join NDL group 110-b and receive a newly generated unicast key sent by the member device 105. Data transferred between the joining device 130 and the member device 105 over the second data link (e.g., within NDL group 110-b) may be encrypted and/or decrypted using the newly generated unicast key and any previously generated keys are discarded.

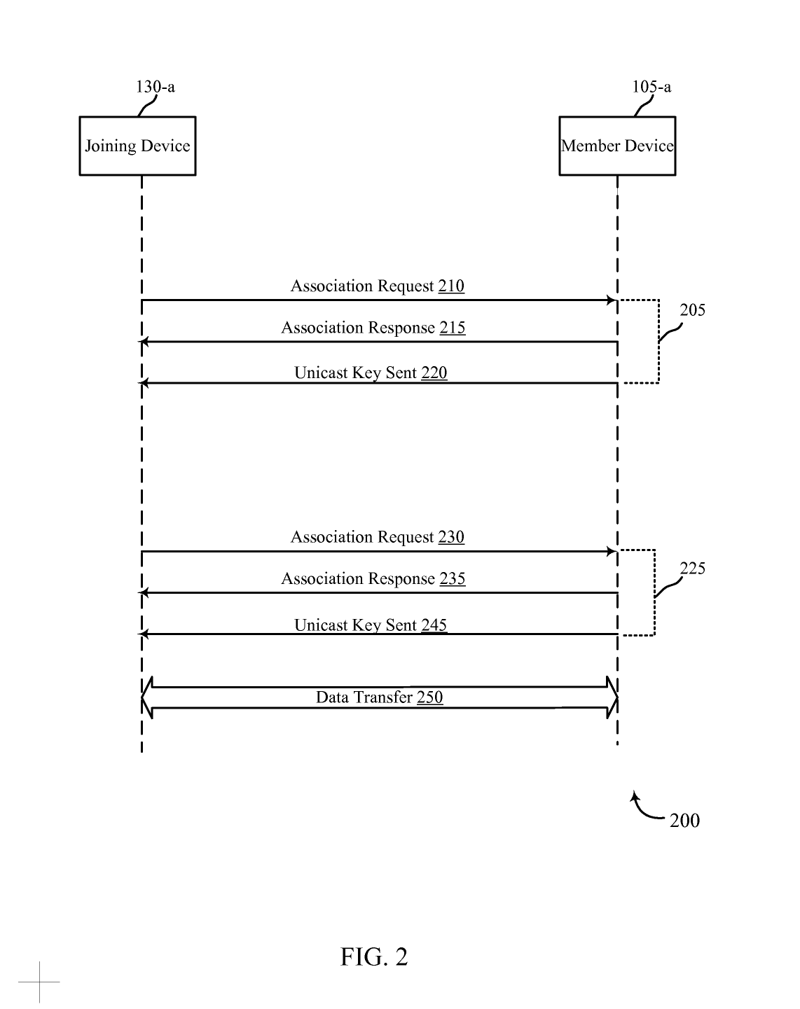

FIG. 2 shows an example message flow diagram 200 of aspects of communications for use in wireless communication, in accordance with various aspects of the present disclosure. Diagram 200 illustrates communications between a joining device 130-a and a member device 105-a. More specifically, FIG. 2 shows communications between joining device 130-a and member device 105-a over two separate association procedures 205 and 225. Association procedure 205 may correspond to communications over first data link 135 to/from NDL group 110-a, where association procedure 225 may correspond to communications over second data link 140 to NDL group 110-b. The joining device 130-a may be an example of the joining device 130 and the member device 105-a may be an example of the member device 105 of FIG. 1.

In one embodiment, joining device 130-a join NDL group 110-a by associating with member device 105-a. Member device 105-a receives an association request 210 from joining device 130-a. After authenticating the joining device 130-a, member device 105-a may send an association response 215 to the joining device 130-a. Upon receiving the association response, an association may be established between the two devices over a first data link, such as the first data link 135 illustrated in FIG. 1. The joining device 130-a may receive a unicast key 220 from member device 105-a (and thus NDL group 110-a). The unicast key may be used for encrypting traffic between the joining device 130-a and the NDL group 110-a.

The joining device 130-a may then take steps to exchange data with NDL group 110-b. The joining device 130-a may engage in a second associate procedure 225 with member device 105-a, where member device 105-a is a member of both NDL groups 110-a and 110-b. In the second association procedure 225, member device 105-a receives an association request 230 from joining device 130-a. After authenticating the joining device 130-a, member device 105-a sends an association response 235 to the joining device 130-a to establish an association between the two devices over a second data link, such as the second data link 140 illustrated in FIG. 1. The joining device 130-a may receive a new unicast key 245 from the member device 105-a (and thus NDL group 110-b). The unicast key 220 sent in the previous association procedure described above is discarded, and the joining device 130-a uses the new unicast key 245 to exchange data with both the devices of NDL group 110-a and NDL group 110-b using the single (and most recently created) unicast key.

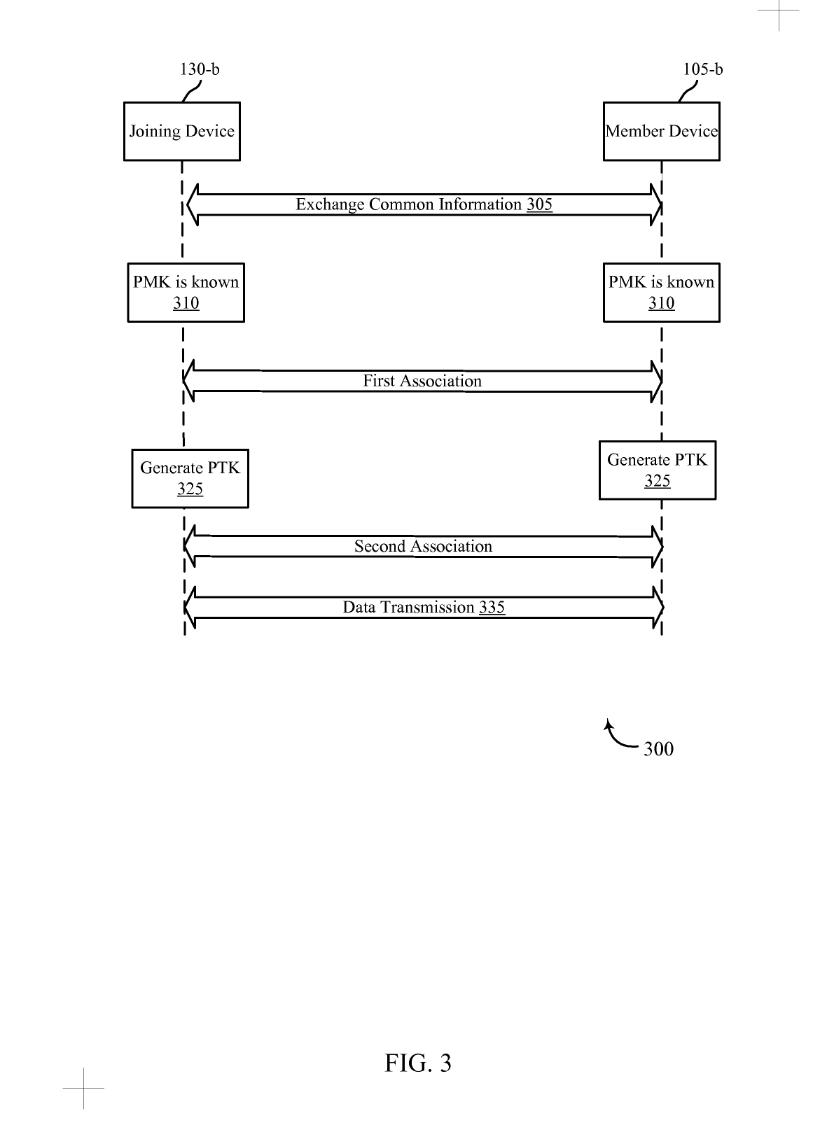

FIG. 3 shows an example message flow diagram 300 of aspects of communications for use in wireless communication, in accordance with various aspects of the present disclosure. Diagram 300 illustrates communications between a joining device 130-b and a member device 105-b. The joining device 130-b may be an example of the joining devices 130 illustrated in FIGS. 1 and 2. The member device 105-b may be an example of the member devices 105 illustrated in FIGS. 1 and 2.

In one embodiment, joining device 130-b seeks to exchange data with devices which are members of second NDL group 110-b, where joining device 130-b has previously associated with member device 105-b on NDL group 110-a. The associations between the joining device 130-b and the member device 105-b may be enabled in part by sharing a common password or other shared data at communication 305 in FIG. 3. For example, the joining device 130-b may send the common password to the member device 105-b, and in return, the member device 105-b may send the common password to the joining device 130-b.

In one embodiment, data exchanged between joining device 130-b and NDL groups 110-a and 110-b (by way of association with member device 105-b) involves consideration of a pairwise master key (PMK) and a pairwise transient key (PTK). Generally, a PMK may be derived from an Extensible Authentication Protocol (EAP) method or may be obtained from a pre-shared key (PSK). In the association procedure between the joining device 130-b and the member device 105-b, the PMK is known. Thus, after the communication 305 of the common data exchange, in one embodiment, devices 130-b and 105-b each associate with one another using PMK 310. After the PMK is confirmed to be valid and current, in some embodiments, a new PTK may be generated, or a previous PTK may be used to encrypt data transfer between the devices. Generally, a PTK is a key derived from the PMK using a four-way handshake.

In one embodiment, the joining device 130-b and the member device 105-b determine whether a previous association exists between the two devices. If a previous association does not exist, a new PTK 325 is generated. PTK 325 is then used to encrypt and decrypt data over data transmission 335.

If a previous association between the two devices does exist (i.e., association with respect to NDL group 110-a), then a previously generated PTK may be used for the data transmission 335, a new PTK need not be generated, and the PTK generated from the previous association is used to encrypt and decrypt data over data transmission 335.

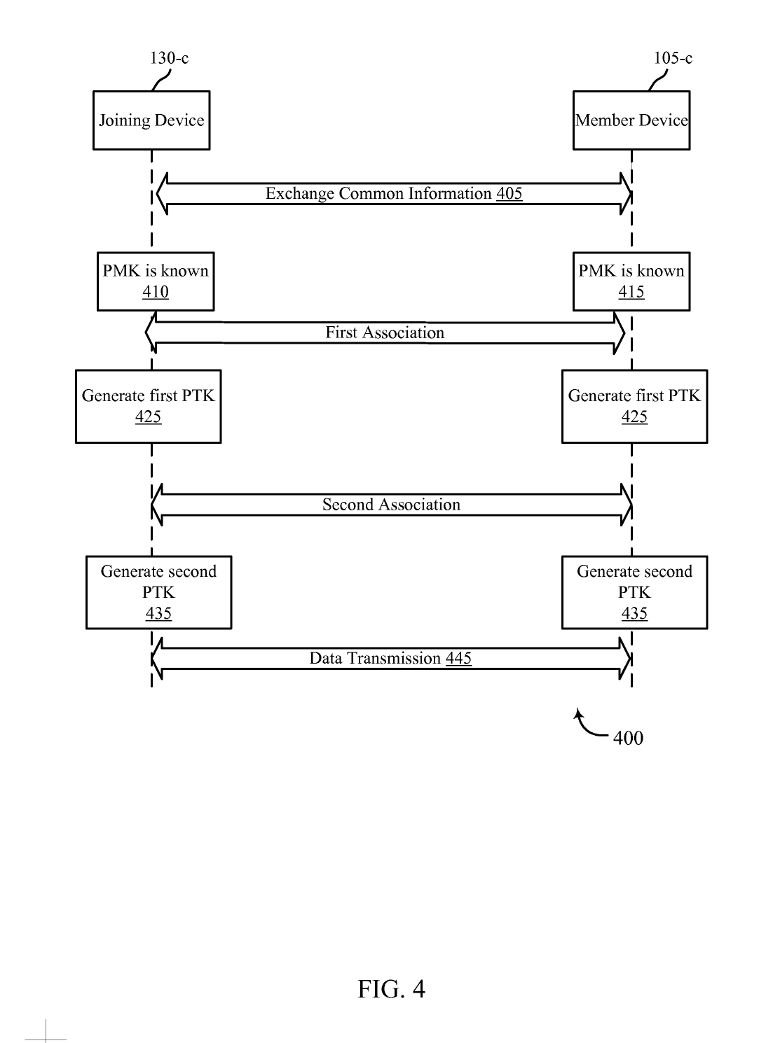

FIG. 4 shows an example message flow diagram 400 of aspects of communications for use in wireless communication, in accordance with various aspects of the present disclosure. Diagram 400 illustrates communications between a joining device 130-c and a member device 105-c. The joining device 130-c may be an example of the joining devices 130 illustrated in FIGS. 1, 2, and 3. The member device 105-c may be an example of the member devices 105 illustrated in FIGS. 1, 2, and 3.

In one embodiment, joining device 130-c seeks to exchange data with devices which are members of NDL group 110-a and NDL group 110-b. The associations between the joining device 130-c and the member device 105-c may be enabled in part by sharing a common password or other shared data at communication 405 in FIG. 3. For example, the joining device 130-c may send the common password to the member device 105-c, and in return, the member device 105-c may send the common password to the joining device 130-c.

In one embodiment, data exchanged between joining device 130-c and NDL groups 110-a and 110-b (by way of association with member device 105-c) involves consideration of a PMK and a PTK. Before a first association procedure between the joining device 130-c and the member device 105-c, the PMK 410 is known. After the common data exchange 405, in one embodiment, devices 130-c and 105-c each associate with one another using PMK 410. After the PMK is confirmed to be valid and current, in some embodiments, a first PTK 425 may be generated from the PMK on joining device 130-c and member device 105-c. First PTK 425 is a new session key that may be used to encrypt and decrypt data transmissions with regard to NDL group 110-a.

In order for joining device 130-c to exchange data with NDL group 110-b, joining device 130-c may establish a second association with member device 105-c. In the second association with member device 105-c in NDL group 110-b, a second PTK 435 is generated and used to encrypt and decrypt data transmissions with regard to NDL group 110-b. Thus, first PTK 425 may be used to encrypt data on NDL group 110-a, whereas the second PTK 435 is used to encrypt data on NDL group 110-b. In one embodiment, previous association between the devices may result in separately generated PTKs for each NDL group.

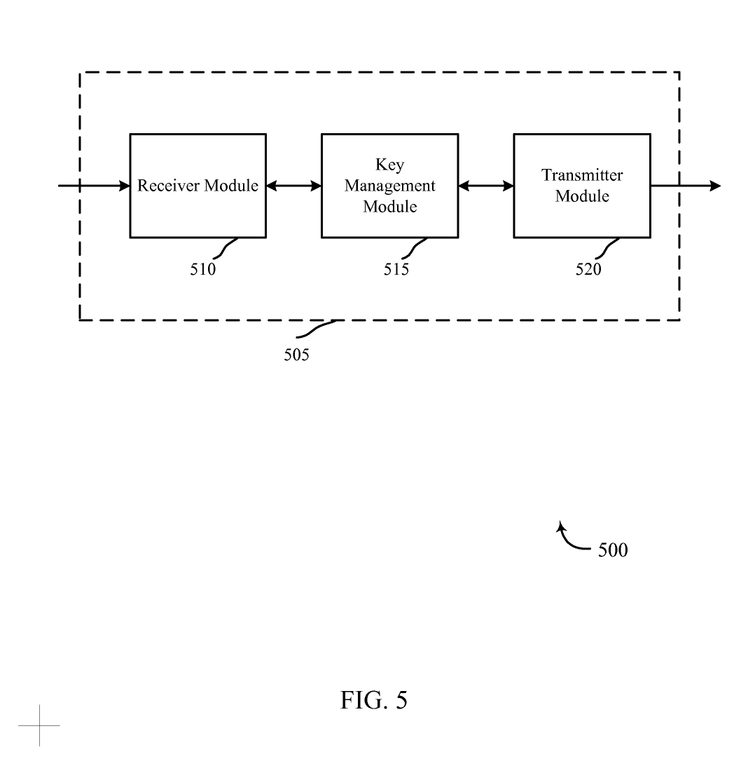

FIG. 5 shows a block diagram 500 of a device 505 for use in wireless communications, in accordance with various aspects of the present disclosure. The device 505 may be an example of one or more aspects of devices 105 and/or 115 illustrated in FIGS. 1-4. The device 505 may include a receiver module 510, a key management module 515, and/or a transmitter module 520. The device 505 may also be or include a processor. Each of these modules may be in communication with each other.

The device 505, through the receiver module 510, the key management module 515, and/or the transmitter module 520, may be configured to perform functions described herein. For example, if the device 505 is a joining device, device 505 may be configured to join multiple NDL groups by associating with a member device which is already a member of the desired multiple NDL groups.

The components of the device 505 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by one or more general or application-specific processors.

The receiver module 510 may receive information such as packets, user data, and/or control information associated with various information channels (e.g., control channels, data channels, etc.). The receiver module 510 may be configured to receive requests regarding authentication and association between devices. In addition, the receiver module 510 may be configured to receive unicast keys, PMKs, and/or PTKs. Information may be passed on to the key management module 515, and to other components of the device 505.

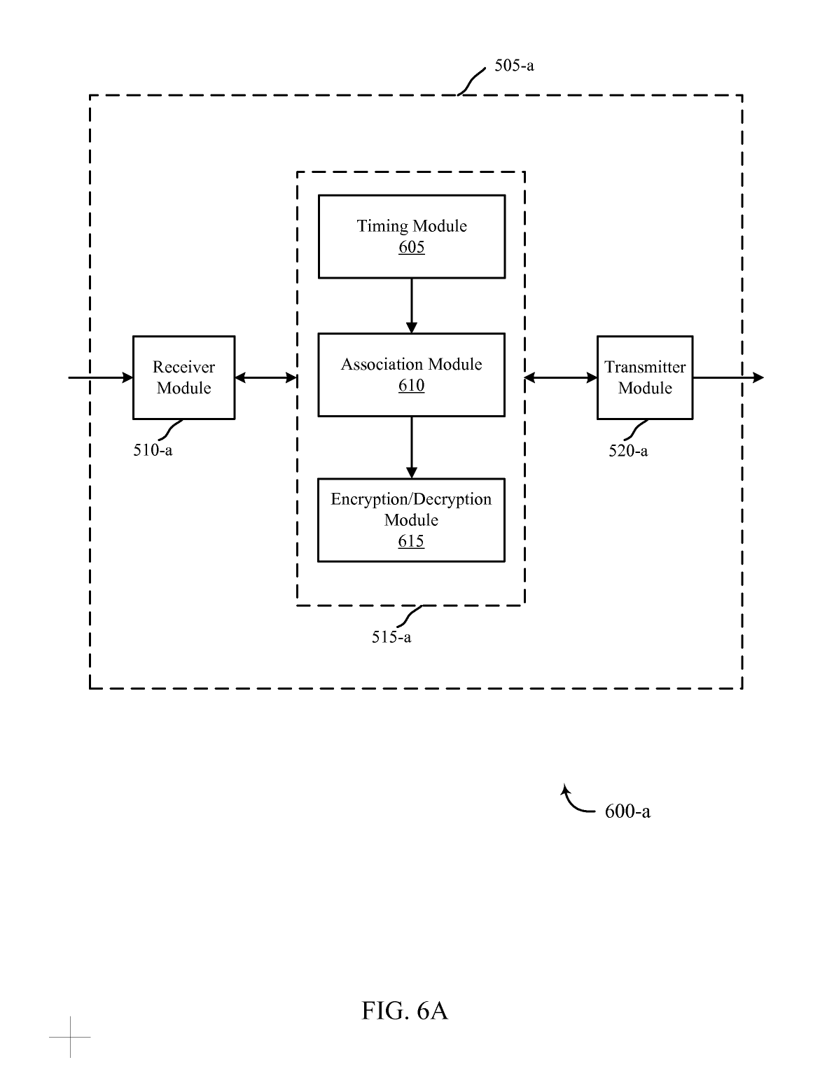

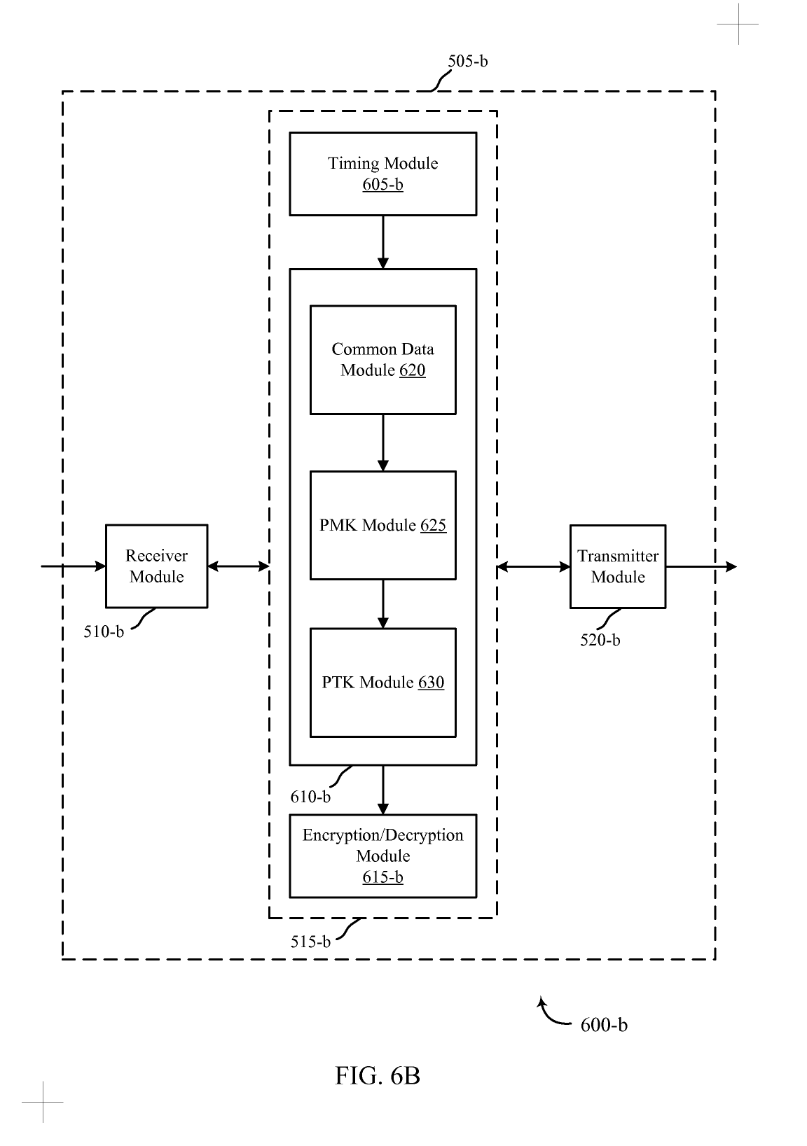

The key management module 515 may monitor, control, and/or manage aspects of authentication, association, and encryption/decryption with regard to a plurality of keys. For example, in establishing an association between a first device and a second device, the key management module 515 may generate a PMK and/or a PTK. In another example, the key management module 515 may utilize a unicast key to encrypt and/or decrypt data transmissions between the first device and the second device within multiple NDL group. In yet still another example, the key management module 515 may make determinations regarding when new keys are generated, which keys are used for which transactions (and between which associated devices), and which keys should be discarded. Generating, using, and discarding keys are discussed in more detail with regard to FIGS. 6A and 6B.

The transmitter module 520 may transmit information regarding authentication, association, and encryption/decryption, associated with managing unicast keys across multiple NDL groups. In some examples, the transmitter module 520 may be collocated with the receiver module 510 in a transceiver component. The transmitter module 520 may include a single antenna, or it may include a plurality of antennas.

FIG. 6A shows a block diagram 600-a of a device 505-a for use in wireless communications, in accordance with various aspects of the present disclosure. The device 505-a may be an example of one or more aspects of devices 105 and/or 115 referred to with respect to FIGS. 1-5. The device 505-a may include a receiver module 510-a, a key management module 515-a, and/or a transmitter module 520-a, which may be examples of the corresponding components of device 505 from FIG. 5. The device 505-a may also be or include a processor. Each of these components may be in communication with each other. The key management module 515-a may include a timing module 605, an association module 610, and an encryption/decryption module 615. The receiver module 510-a and the transmitter module 520-a may perform the functions of the receiver module 510 and the transmitter module 520, of FIG. 5, respectively.

The components of the device 505-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by one or more general or application-specific processors.

The timing module 605 may synchronize communications between devices with regard to one or more NDL groups. In one embodiment, the NDL group, such as NDL groups 110-a or 110-b described with reference to FIGS. 1 and 2, may be a synchronized network, i.e., all of the member devices 105 and 115 may share a common timing reference to enable synchronized communications. The shared reference timing includes a paging period at the beginning of a data transmission session window as well as a data transmission period. In some embodiments, the NDL member devices wake up during the paging period to determine whether there is any traffic to be sent. If there is traffic to be sent, the NDL member device(s) 105 and/or 115 may remain awake during the data transmission period to exchange the traffic. If there is no traffic being sent, the NDL devices 105 and/or 115 may transition back to a sleep state during the data transmission period.

The association module 610 may manage an authentication and association procedure which enables a joining device to associate with a member device and join an NDL group. In one embodiment, the authentication and association procedure may involve a four-way handshake. It is assumed that before the four-way handshake beings, the joining device 130-c and the member device 105-c found each other and agreed to proceed with the association procedure. Thus, the four-way handshake enables the joining device 130-c to join a first existing NDL group (e.g., NDL group 110-a) by way of a single association procedure.

In one embodiment, the joining device 130 may request a first association with the member device 105. Upon receipt of the first association request, the member device 105 attempts to verify the received identity of the joining device 130. If the identity is verified, the joining device 130 receives a unicast key, and the joining device 130 may now exchange data with all of devices 105 and 115-a, 115-b, 115-c, and 115-d of NDL group 110-a. Joining device 130, however, also wishes to exchange data with devices 115-e, 115-f, 115-g, and 115-h of NDL group 110-b.

To exchange data within the NDL group 110-b, the joining device 130 requests a second association with the member device 105. After the authentication procedure described previously, the joining device 130 receives a new unicast key from member device 105. The previous unicast key may be discarded. The new unicast key enables the joining device 130 and the member device 105 to encrypt and decrypt traffic between them (and thus between the joining device 130 and both NDL groups 110-a and 110-b by way of associating with member device 105).

The encryption/decryption module 615 may be configured to perform security operations for communications between the joining device 130 and one or more of the member devices 105 and/or 115 once the joining device 130 has joined one or more of the NDL groups. Because the communications within the NDL groups should be secure, the encryption/decryption module 615 may encrypt messages to be transmitted from the joining device 130 and may decrypt messages received from member devices 105 and/or 115 as part of communications within the NDL groups 110-a and/or 110-b.

FIG. 6B shows a block diagram 600-b of a device 505-b for use in wireless communications, in accordance with various aspects of the present disclosure. The device 505-b may be an example of one or more aspects of devices 105 and/or 115 and/or 505-a referred to with respect to FIGS. 1-6A. The device 505-b may include a receiver module 510-b, a key management module 515-b, and/or a transmitter module 520-b, which may be examples of the corresponding components of device 505 from FIG. 5 and/or device 505-a from FIG. 6A. The device 505-b may also be or include a processor. Each of these components may be in communication with each other.

The components of the device 505-b may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by one or more general or application-specific processors.

The key management module 515-b may include a timing module 605-b, an association module 610-b, and an encryption/decryption module 615-b. The timing module 605-b and the encryption/decryption module 615-b may perform the functions of the timing module 605-a and the encryption/decryption module 615-a of FIG. 6A, respectively. The receiver module 510-b and the transmitter module 520-b may perform the functions of the receiver module 510 and the transmitter module 520 of FIG. 5, respectively, and/or receiver module 510-a and the transmitter module 520-a of FIG. 6A, respectively.

In one embodiment, association module 610-b may include a common data module 620, a PMK module 625, and/or a PTK module 630.

In one embodiment, association between a joining device 130 and a member device 105 may be enabled in part by sharing a common password or other shared data. Common data module 620 may communicate the shared data between the joining device 130 and the member device 105. In a first message, the joining device 130 may send the common password to the member device 105. In a second message, the member device 105 may send the common password to the joining device 130.

After the common password exchange, in one embodiment, the PMK module 625 generates a pairwise master key for the joining device 130. The member device 105 may also have a PMK module which generates a PMK.

The PTK module 630 generates at least a pairwise transient key (PTK) using the PMK generated by the PMK module 625. As with the PMK, the member device 105 may also have a PTK module which generates a new PTK. In other embodiments, the PTK module 630 does not generate a new PTK, but uses a previously generated PTK.

In yet another embodiment, a first PTK may be used to encrypt unicast traffic between the joining device 130 and the member device 105 with respect to a first association. Similarly, a second PTK may be used to encrypt unicast traffic between the joining device 130 and the member device 105 with respect to a second association. Thus, in this embodiment, each new unicast association between the same two devices (e.g., joining device 130 and member device 105) generates a new PTK.

The member device 105 may send a data frame comprising header information indicating, for example, a unique 802.11 MAC address for each NDL group with which the member device 105 communicates. The MAC address may be included at the Address 3 (A3) field of each data frame that carries data for each specific NDL group. When the joining device 130 receives the data frame, the NDL group MAC address and the Sender Address (A2) is mapped to determine which of the two PTKs should be used to decrypt the communications between joining device 130 and member device 105.

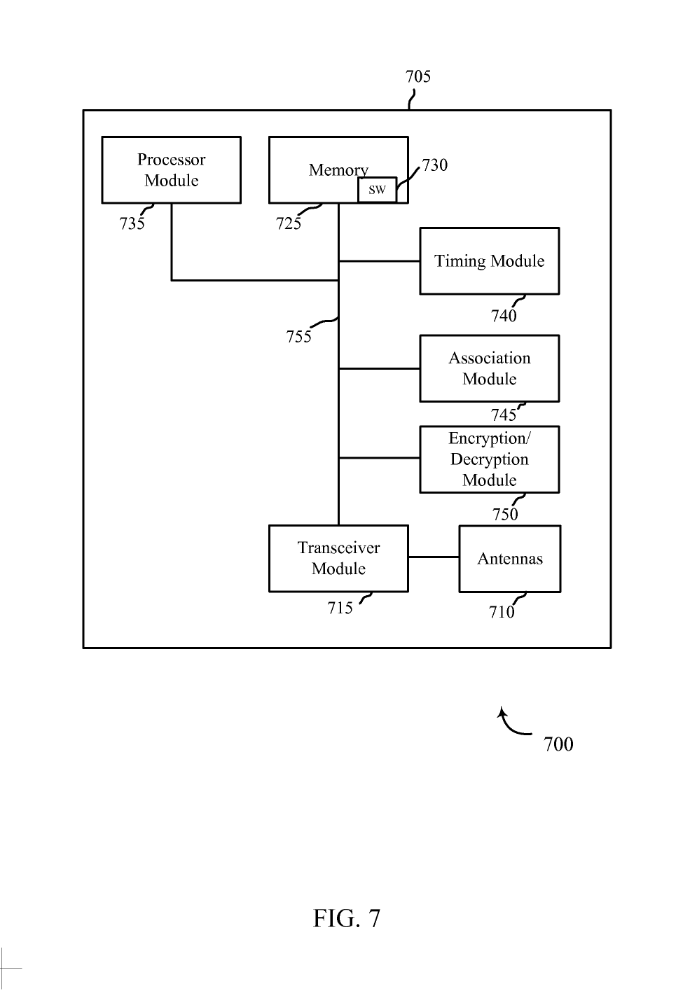

Turning to FIG. 7, a diagram 700 is shown that illustrates a wireless device 705 configured for unicast key management across multiple NDL groups. The wireless device 705 may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The wireless device 705 may have an internal power supply, such as a small battery, to facilitate mobile operation. The wireless device 705 may be an example of the devices 105, 115, 130, and/or 505 of FIGS. 1-6B.

The wireless device 705 may include a processor module 735, a memory module 725, a transceiver module 715, antennas 710, a timing module 740, an association module 745, and an encryption/decryption module 750. The timing module 740, association module 745, and encryption/decryption module 750 may be examples of the timing module 605, association module 610, and encryption/decryption module 615, respectively, of FIG. 6A. Each of these modules may be in communication with each other, directly or indirectly, over at least one bus 755.

The memory module 725 may include RAM and ROM. The memory module 725 may store computer-readable, computer-executable software (SW) code 730 containing instructions that are configured to, when executed, cause the processor module 735 to perform various functions described herein for unicast key management across multiple NDL groups. Alternatively, the software code 730 may not be directly executable by the processor module 735 but be configured to cause the computer (e.g., when compiled and executed) to perform functions described herein.

The processor module 735 may include an intelligent hardware device, e.g., a CPU, a microcontroller, an ASIC, etc. The processor module 735 may process information received through the transceiver module 715 and/or to be sent to the transceiver module 715 for transmission through the antennas 710. The processor module 735 may handle, alone or in connection with the timing, key management, and encryption/decryption modules, various aspects for unicast key management across multiple NDL groups.

The transceiver module 715 may be configured to communicate bi-directionally with devices 105, 115, 130, and/or 505 in FIGS. 1-6B. The transceiver module 715 may be implemented as at least one transmitter module and at least one separate receiver module. The transceiver module 715 may include a modem configured to modulate the packets and provide the modulated packets to the antennas 710 for transmission, and to demodulate packets received from the antennas 710. While each device 105, 115, 130, and/or 505 may include a single antenna, there may be aspects in which the devices 105, 115, 130, and/or 505 may include multiple antennas 710.

The components of the wireless device 705 may be configured to implement aspects discussed above with respect to FIGS. 1-6B; however, those aspects may not be repeated here for the sake of brevity.

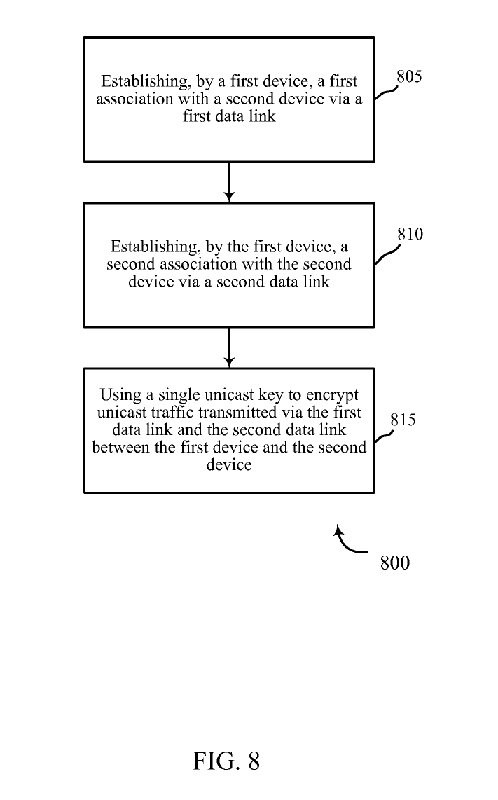

FIG. 8 is a flow chart illustrating an example of a method 800 for wireless communication, in accordance with various aspects of the present disclosure. For clarity, the method 800 is described below with reference to aspects of one or more of the devices 105, 115, 130, 505, and/or 705 described with reference to FIGS. 1-7. In some examples, a wireless device may execute one or more sets of codes to control the functional elements of the wireless device to perform the functions described below. Additionally or alternatively, the wireless device may perform one or more of the functions described below using-purpose hardware.

At block 805, the method 800 may include establishing, by a first wireless device, a first association with a second wireless device by way of a first data link. At block 810, the method 800 may include establishing, by the first wireless device, a second association with the second wireless device by way of a second data link. The operations at blocks 805 and 810 may be performed using the key management module 515 described with reference to FIG. 5.

At block 815, the method 800 may include using a single unicast key to encrypt unicast traffic transmitted by way of the first data link and the second data link between the first device and the second device. The operation at block 815 may be performed using the encryption/decryption module 615 described with reference to FIGS. 6A and/or 6B.

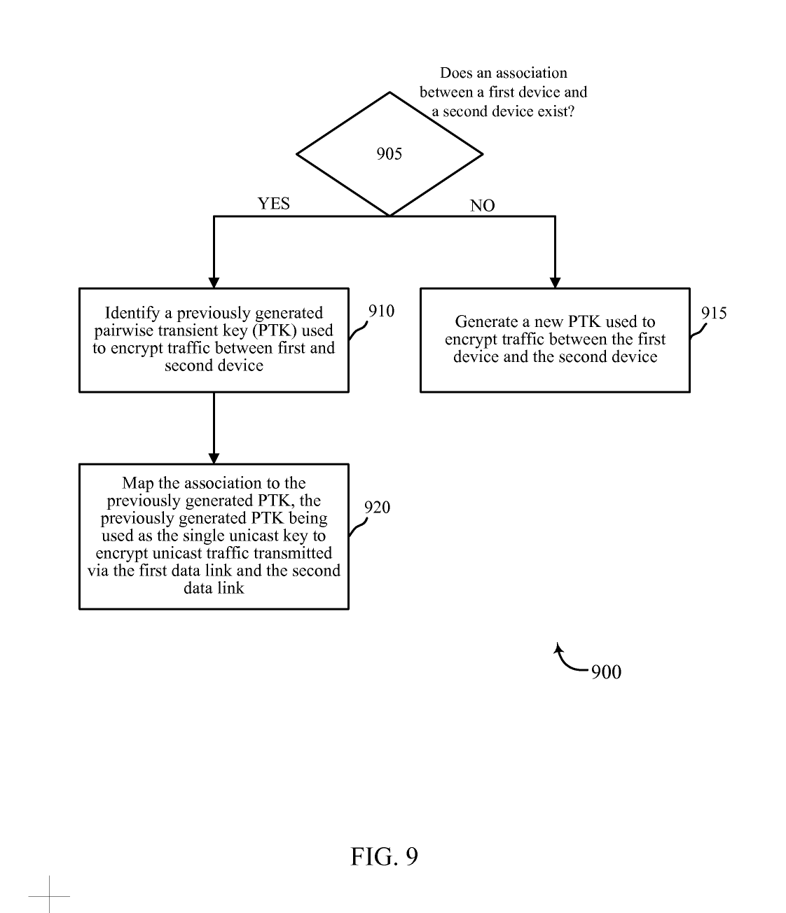

FIG. 9 is a flow chart illustrating an example of a method 900 for wireless communication, in accordance with various aspects of the present disclosure. For clarity, the method 900 is described below with reference to aspects of one or more of the devices 105, 115, 130, 505, and/or 705 described with reference to FIGS. 1-7. In some examples, a wireless device may execute one or more sets of codes to control the functional elements of the wireless device to perform the functions described below. Additionally or alternatively, the wireless device may perform one or more of the functions described below using-purpose hardware.

At block 905, the method 900 may include determining whether an association between a first wireless device and a second wireless device exists. The operation at block 905 may be performed using at least the key management module 515 of FIG. 5.

If an association already exists, at block 910, the method includes identifying a previously generated PTK being used to encrypt traffic between the first and the second device. Subsequently, at block 920, the method 900 may include mapping the association to the previously generated PTK, where the previously generated PTK is used as a single unicast key to encrypt unicast traffic transmitted via a first data link and a second data link between the first device and the second device. The operations at blocks 915 and 920 may be performed using the association module 610 and/or encryption/decryption module 615 of FIG. 6A.

If it is determined at decision block 905 that a previous association does not exist, at block 915, the method 900 includes generating a new PTK to be used for encrypting traffic between the first device and the second device. The operation at block 915 may be performed using the association module 610 and/or encryption/decryption module 615 of FIG. 6A, and more specifically the PTK module 630 of FIG. 6B.

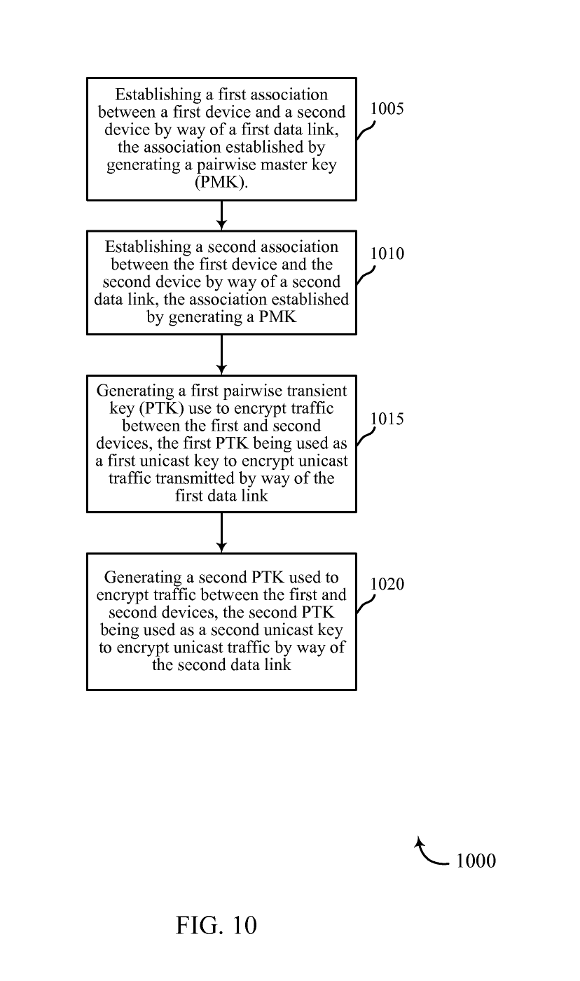

FIG. 10 is a flow chart illustrating an example of a method 1000 for wireless communication, in accordance with various aspects of the present disclosure. For clarity, the method 1000 is described below with reference to aspects of one or more of the devices 105, 115, 130, 505 and/or 705 described with reference to FIGS. 1-7. In some examples, a wireless device may execute one or more sets of codes to control the functional elements of the wireless device to perform the functions described below. Additionally or alternatively, the wireless device may perform one or more of the functions described below using-purpose hardware.

At block 1005, the method 1000 may include establishing a first association between a first device and a second device by way of a first data link, the association established by generating a PMK. At block 1010, the method 1000 may include establishing a second association between the first device and the second device by way of a second data link, the association established by generating a PMK. In some embodiments, the operations at blocks 1005 and 1010 may be performed using the association module 610 of FIG. 6B, and more specifically, the PMK module 625 of FIG. 6B.

At block 1015, the method 1000 may include generating a first PTK use to encrypt traffic between the first device and the second device, the first PTK being used as a first unicast key to encrypt unicast traffic transmitted by way of the first data link. At block 1020, the method 1000 may include generating a second PTK used to encrypt traffic between the first device and the second device, the second PTK being used as a second unicast key to encrypt unicast traffic by way of the second data link. In some embodiments, the operations at blocks 1015 and 1020 may be performed using at least the PTK module 630 of FIG. 6B.

In some examples, aspects from two or more of the methods 800, 900, and 1000 may be combined. It should be noted that the methods 800, 900, and 1000 are just example implementations, and that the operations of the methods 800, 900, and 1000 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
establishing, by a first device, a first association with a second device via a first data link;
establishing, by the first device, a second association with the second device via a second data link; and
using a single unicast key to encrypt unicast traffic transmitted via the first data link and the second data link between the first device and the second device.

2. The method of claim 1, wherein the first data link comprises a first neighbor aware network (NAN) data link (NDL) and the second data link comprises a second NDL, the second NDL being different from the first NDL.

3. The method of claim 1, further comprising:
generating a first unicast key to encrypt unicast traffic transmitted via the first data link; and
generating a second unicast key to encrypt unicast traffic transmitted via the second data link.

4. The method of claim 3, further comprising:
identifying a first pairwise transient key (PTK) used to encrypt unicast traffic between the first device and the second device, the first PTK being used as the first unicast key;
identifying a second PTK used to encrypt unicast traffic between the first device and the second device, the second PTK being used as the second unicast key;
receiving, from the second device, a data frame comprising header information;
selecting one of the first PTK or the second PTK based on the header information; and
decrypting the data frame based on the selected PTK.

5. The method of claim 3, further comprising:
identifying the first unicast key as being generated prior to the generation of the second unicast key;
discarding the first unicast key based at least in part on the identifying; and
using the second unicast key as the single unicast key to encrypt unicast traffic transmitted via the first data link and the second data link.

6. The method of claim 3, further comprising:
identifying the second association with the second device via the second data link as being an unsecure connection; and
using the first unicast key as the single unicast key to encrypt unicast traffic transmitted via the first data link and the second data link.

7. The method of claim 3, further comprising:
identifying the second association with the second device via the second data link as being an unsecure connection;
using the first unicast key as the single unicast key to encrypt unicast traffic transmitted via the first data link; and
transmitting unencrypted unicast traffic via the second data link.

8. The method of claim 1, further comprising:
maintaining a map that identifies previously established associations between the first device and other devices.

9. The method of claim 8, wherein establishing the second association comprises:
determining an association with the second device was previously established based at least in part on the map;
identifying a previously generated pairwise transient key (PTK) used to encrypt traffic between the first device and the second device; and
mapping the second association to the previously generated PTK, the previously generated PTK being used as the single unicast key to encrypt unicast traffic transmitted via the first data link and the second data link.

10. The method of claim 8, wherein establishing the first association comprises:
determining the first association with the second device was not previously established based at least in part on the map; and
generating a pairwise transient key (PTK) used to encrypt traffic between the first device and the second device, the generated PTK being used as the single unicast key to encrypt unicast traffic transmitted via the first data link and the second data link.

11. The method of claim 1, wherein establishing the first association comprises:
generating a pairwise master key (PMK) with the second device.

12. The method of claim 1, wherein the first association is established prior in time to the establishment of the second association.

13. An apparatus for wireless communications, comprising:
a key manager to establish a first association between a first device and a second device by way of a first data link;
the key manager further configured to establish a second association between the first device and the second device by way of a second data link; and
the key manager further utilizing a single unicast key to encrypt unicast traffic between the first device and the second device transmitted by way of the first data link and the second data link.

14. The apparatus of claim 13, wherein the key manager is further configured to:
generate a first unicast key to encrypt unicast traffic transmitted by way of the first data link; and
generate a second unicast key to encrypt unicast traffic transmitted by way of the second data link.

15. The apparatus of claim 13, wherein the key manager is further configured to:
generate a first pairwise transient key (PTK) used to encrypt traffic between the first device and the second device, the first PTK being used as a first unicast key to encrypt unicast traffic transmitted via the first data link; and
generate a second PTK used to encrypt traffic between the first device and the second device, the second PTK being used as a second unicast key to encrypt unicast traffic transmitted via the second data link.

16. The apparatus of claim 14, wherein the key manager is further configured to:
identify the first unicast key as being generated prior to the generation of the second unicast key;
discard the first unicast key based at least in part on the identifying; and
use the second unicast key as the single unicast key to encrypt unicast traffic transmitted via the first data link and the second data link.

17. The apparatus of claim 13, wherein the key manager is further configured to:
maintain a map that identifies previously established associations between the first device and other devices.

18. The apparatus of claim 17, wherein the key manager is further configured to:
determine an association with the second device was previously established based at least in part on the map;
identify a previously generated pairwise transient key (PTK) used to encrypt traffic between the first device and the second device; and
map the second association to the previously generated PTK, the previously generated PTK being used as the single unicast key to encrypt unicast traffic transmitted via the first data link and the second data link.

19. The apparatus of claim 17, wherein the key manage is further configured to:
determine the first association with the second device was not previously established based at least in part on the map; and
generate a pairwise transient key (PTK) used to encrypt traffic between the first device and the second device, the generated PTK being used as the single unicast key to encrypt unicast traffic transmitted via the first data link and the second data link.

20. The apparatus of claim 13, wherein the key manager is further configured to:
generate a pairwise master key (PMK) with the second device.

21. An apparatus for wireless communication, comprising:
means for establishing, by a first device, a first association with a second device via a first data link;
means for establishing, by the first device, a second association with the second device via a second data link; and
means for using a single unicast key to encrypt unicast traffic transmitted via the first data link and the second data link between the first device and the second device.

22. The apparatus of claim 21, wherein the first data link comprises a first neighbor aware network (NAN) data link (NDL) and the second data link comprises a second NDL, the second NDL being different from the first NDL.

23. The apparatus of claim 21, further comprising:
means for generating a first unicast key to encrypt unicast traffic transmitted via the first data link; and
means for generating a second unicast key to encrypt unicast traffic transmitted via the second data link.

24. The apparatus of claim 23, further comprising:
means for generating a first pairwise transient key (PTK) used to encrypt traffic between the first device and the second device, the first PTK being used as a first unicast key to encrypt unicast traffic transmitted via the first data link; and
means for generating a second PTK used to encrypt traffic between the first device and the second device, the second PTK being used as a second unicast key to encrypt unicast traffic transmitted via the second data link.

25. The apparatus of claim 23, further comprising:
means for identifying the first unicast key as being generated prior to the generation of the second unicast key;
means for discarding the first unicast key based at least in part on the identifying; and
means for using the second unicast key as the single unicast key to encrypt unicast traffic transmitted via the first data link and the second data link.

26. The apparatus of claim 23, further comprising:
means for identifying the second association with the second device via the second data link as being an unsecure connection; and
means for using the first unicast key as the single unicast key to encrypt unicast traffic transmitted via the first data link and the second data link.

27. The apparatus of claim 23, further comprising:
means for identifying the second association with the second device via the second data link as being an unsecure connection;
means for using the first unicast key as the single unicast key to encrypt unicast traffic transmitted via the first data link; and
means for transmitting unencrypted unicast traffic via the second data link.

28. The apparatus of claim 21, further comprising:
means for maintaining a map that identifies previously established associations between the first device and other devices.

29. The apparatus of claim 28, wherein establishing the second association comprises:
means for determining an association with the second device was previously established based at least in part on the map;
means for identifying a previously generated pairwise transient key (PTK) used to encrypt traffic between the first device and the second device; and
means for mapping the second association to the previously generated PTK, the previously generated PTK being used as the single unicast key to encrypt unicast traffic transmitted via the first data link and the second data link.

30. A non-transitory computer-readable medium storing code for wireless communication, the code comprising instructions executable to:
establish a first association between a first device and a second device by way of a first data link;
establish a second association between the first device and the second device by way of a second data link; and
use a single unicast key to encrypt unicast traffic between the first device and the second device transmitted by way of the first data link and the second data link.
